(19) United States
(12) Patent Application Publication
(10) Pub. No.: US 2026/0252643 A1
(43) Pub. Date: Aug. 27, 2026

(54) GENERATING DIGITAL CREDENTIAL RECOMMENDATIONS USING NEURAL NETWORKS

(71) Applicant: GDM Holding LLC, Mountain View, CA (US)

(72) Inventors: Danny Karmon, Petah Tikva (IL); Ilia Labzovsky, Tel Aviv-Yafo (IL)

(21) Appl. No.: 19/064,559

(22) Filed: Feb. 26, 2025

(51) Int. Cl. G06F 16/9535; G06F 16/9537; G06F 16/9538; G06N 3/08

(52) U.S. Cl. CPC G06F 16/9535; G06F 16/9537; G06F 16/9538; G06N 3/08

(57) ABSTRACT

Methods, systems, and apparatus, including computer programs encoded on a computer storage medium, for receiving a request to identify a set of one or more relevant digital credentials from a plurality of digital credentials associated with a digital credential application on a mobile device; identifying a context for the request; identifying, as candidate digital credentials, a subset of the digital credentials associated with the digital credential application; processing an input comprising (i) the context for the request and (ii) data characterizing each of the candidate digital credentials using a neural network to generate an output that defines a relevance ranking of the candidate digital credentials given the context for the request; selecting, as the set of one or more relevant digital credentials, one or more of the candidate digital credentials using the output; and presenting, on the mobile device, data representing the set of one or more relevant digital credentials.

### BACKGROUND

This specification relates to generating digital credential recommendations using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

A digital credential application is a digital version of a physical credential that can store data representing one or more digital credentials. Examples of digital credentials include items such as cards, certificates, and tickets.

### SUMMARY

This specification describes a system implemented as computer programs on one or more computers in one or more locations that can generate one or more relevant digital credential recommendations for the user based on a given context.

According to a first aspect there is provided a method performed by one or more computers, the method comprising: receiving a request to identify a set of one or more relevant digital credentials from a plurality of digital credentials associated with a digital credential application on a mobile device, wherein each digital credential is associated with respective information that is communicated to a corresponding recipient device when (i) the digital credential is designated as active within the digital credential application and (ii) a communication criterion is satisfied; identifying a context for the request; identifying, as candidate digital credentials, a subset of the digital credentials associated with the digital credential application; processing an input comprising (i) the context for the request and (ii) data characterizing each of the candidate digital credentials using a neural network to generate a neural network output that defines a relevance ranking of the candidate digital credentials given the context for the request; selecting, as the set of one or more relevant digital credentials, one or more of the candidate digital credentials using the neural network output; and presenting, on the mobile device, data representing the set of one or more relevant digital credentials.

In some implementations, the method further comprises: after presenting the data representing the set of one or more relevant digital credentials: determining that the communication criterion is satisfied between the mobile device and a particular recipient device; and in response, communicating the respective information associated with one of the relevant digital credentials to the particular recipient device.

In some implementations, wherein the set of one or more relevant digital credentials includes only one relevant digital credential and wherein the method further comprises: designating the relevant digital credential as active within the digital credential application.

In some implementations, wherein the set of one or more relevant digital credentials includes a plurality of relevant digital credentials and wherein the method further comprises: after presenting the data representing the set of relevant digital credentials on the mobile device, receiving a user input selecting one of the relevant digital credentials; and designating the selected relevant digital credential as active within the digital credential application.

In some implementations, the method further comprises: identifying that the respective information associated with a particular digital credential of the plurality of digital credentials was communicated to another device in a particular context; generating a training example identifying the particular context, the particular digital credential, and a particular subset of the digital credentials associated with the digital credential application; and training the neural network using the training example.

In some implementations, the neural network is a pre-trained generative neural network.

In some implementations, the neural network has been trained on training data that includes a plurality of training examples from a plurality of user devices, each training example comprising a respective context identified by a respective user device, a respective set of candidate digital credentials, and a respective digital credential from the respective set of candidate digital credentials that was used in the respective context.

In some implementations, after the training on the training data that includes the plurality of training examples from the plurality of user devices, the neural network has been fine-tuned on training examples that are specific to the mobile device.

In some implementations, the request is a user request to access the digital credential application.

In some implementations, the request is an automated system request for digital credential recommendations that is triggered by detection of a trigger event.

In some implementations, identifying the context for the request comprises identifying data characterizing a semantic location of the mobile device.

In some implementations, identifying the context for the request comprises identifying data characterizing a physical location of the mobile device.

In some implementations, identifying the context for the request comprises identifying data characterizing one or more user activity patterns.

In some implementations, identifying, as candidate digital credentials, the subset of the digital credentials associated with the digital credential application comprises identifying all of the digital credentials associated with the digital credential application as candidate digital credentials.

In some implementations, identifying, as candidate digital credentials, the subset of the digital credentials associated with the digital credential application comprises performing a search of the plurality of digital credentials associated with the digital credential application based on the identified context to identify the subset of digital credentials.

In some implementations, identifying, as candidate digital credentials, the subset of the digital credentials associated with the digital credential application comprises: maintaining data associating each of one or more cached contexts with a respective subset of the digital credentials associated with the digital credential application; determining that the context matches at least one of the cached contexts; and including, in the candidate digital credentials, the respective subsets associated with each of the at least one matching cached context.

Other aspects include systems and non-transitory computer storage media that store instructions that when executed by one or more computers cause the one or more computers to perform the method as described above.

Particular embodiments of the subject matter described in this specification can be implemented so as to realize one or more of the following advantages.

As the number of digital credentials within a digital credential application increases, managing and navigating the digital credential application becomes increasingly complex. Manual selection of a relevant digital credential by a user from an increasing collection of digital credentials may result in inefficiencies and errors, can significantly increase the latency incurred in identifying which digital credential to use at any given time, and can significantly degrade the user experience.

Conventional digital credential applications rely on manual selection by the user to determine which of the existing digital credentials to designate as active within the digital credential application. Conventional digital credential applications thus do not predict or generate digital credential recommendations based on the given context or user behavior. Advantageously, the described system can generate a recommendation of one or more digital credentials relevant to the context that the user is in. Given this recommendation, the user can avoid the time-consuming and error-prone process of sifting through the digital credentials in the digital credential application and manually selecting a digital credential. By having the most relevant digital credential recommendation pre-selected for the user or having a recommendation of a set of digital credentials for the user to choose one from, the described system streamlines the user experience in using, managing, and navigating the digital credential application. The recommendation of one or more digital credentials generated by the described system can also reduce user error that can lead to suboptimal outcomes, such as choosing a wrong digital credential that leads to denied access, not choosing the correct digital credential to use as a payment card that would have maximized rewards or benefits for the user, and so on.

The described system can furthermore generate digital credential recommendations using a neural network that has been customized using parameter updates or gradients learned from a plurality of users, allowing the described system to generate digital credential recommendations relevant to a user even when the user lacks sufficient history to inform the described system of the user's own preferences in the context that the user is in. When the user has sufficient history, the described system can advantageously generate digital credential recommendations using a neural network fine-tuned for the user, allowing the described system to provide digital credential recommendations that are tailored to the user's activity and preferences.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system.

FIG. 2 is a block diagram of an example digital credential recommendation system for generating and presenting relevant digital credentials.

FIG. 3 is a flow diagram of an example process for training of a neural network on-board the mobile device to generate relevant digital credentials.

FIG. 4 is a flow diagram of an example process for further training a pre-trained generative neural network to customize and fine-tune the recommendation of relevant digital credentials.

FIG. 5 is a flow diagram of an example process for identifying and presenting to a user a set of one or more relevant digital credentials.

Like reference numbers and designations in the various drawings indicate like elements.

### DETAILED DESCRIPTION

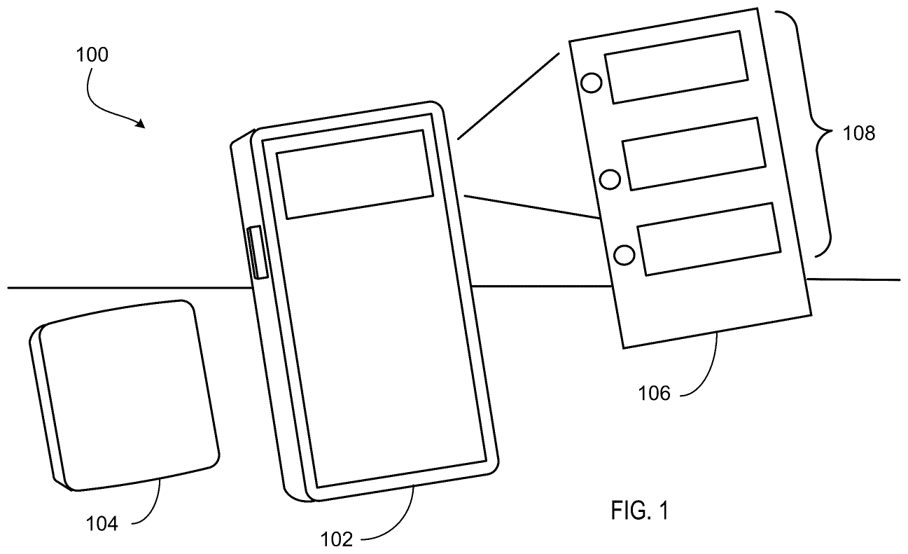

FIG. 1 shows an example system 100. The system 100 includes a mobile device 102 and a corresponding recipient device 104.

The mobile device 102 runs a digital credential application that can store a plurality of digital credentials. A digital credential application is an application that can store data representing one or more digital credentials and allows the user to exchange with a corresponding recipient device 104 data corresponding to the digital credential that is designated as active within the application. Each digital credential is an item associated with information that can be communicated to a corresponding recipient device 104. Some examples of digital credentials include cards, certificates, tickets, and boarding passes that can be used for any of a variety of purposes such as granting access (e.g., to physical locations, to computer systems, etc.), identification, authentication, payment methods, transit passes, health insurance cards, etc.

The digital credential application on the mobile device 102 can receive a request to identify a set of one or more digital credentials that is relevant to a user in a particular context from the plurality of digital credentials.

One example of a request can be a user request to access the digital credential application.

Another example of a request can be an automated system request for digital credential recommendations that is triggered by the detection of a trigger event. A trigger event can be, for instance, detection that the mobile device 102 is approaching a recipient device, such as one that is present at an access point, a checkout counter, a transit station, a healthcare facility, etc.

Another trigger event can be, for example, the detection of the user entering a particular physical or semantic location.

A physical location is a location, e.g., where the mobile device 102 is geographically located.

A semantic location is a particular category of physical location (e.g., different branches of the same store or the same type of store, different airports, different offices of the same facility or type of facility, etc.). Thus, multiple different physical locations can correspond to the same semantic location.

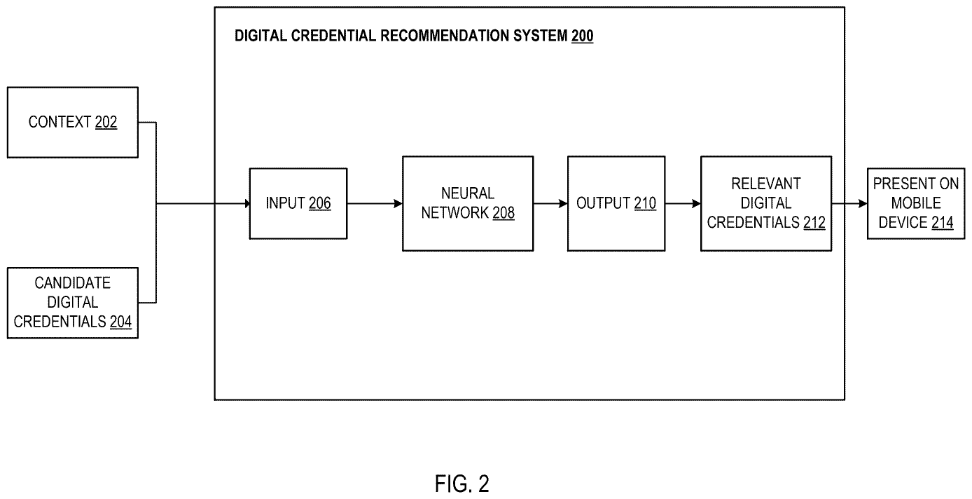

Upon receiving a request to identify a set of one or more relevant digital credentials from the plurality of digital credentials, the mobile device 102 generates a recommendation of a set 106 of one or more relevant digital credentials 108 to be presented on the mobile device 102. Generating one or more relevant digital credential recommendations is described in more detail below with reference to FIG. 2.

In some implementations, the digital credential application automatically surfaces on the mobile device 102 a recommendation of the most relevant digital credential that is pre-selected for use and/or access by the user. In some other implementations, the digital credential application presents on the mobile device 102 a recommendation of a set 106 of one or more relevant digital credentials 108 from which the user can select one digital credential for use and/or access.

Each digital credential is associated with respective information that can be communicated with a corresponding recipient device 104. A corresponding recipient device 104 is any device that is configured to receive this information when this information is communicated by the mobile device 102.

Information associated with a digital credential is communicated with a corresponding recipient device 104 when the digital credential is designated as active within the digital credential application and a communication criterion is satisfied.

A digital credential can be designated as active either automatically by the digital credential application pre-selecting the digital credential or manually by user input selecting the digital credential.

A communication criterion is a communication protocol that enables communication between two devices. Different communication protocols used between the mobile device 102 and the corresponding recipient device 104 can have different communication criteria to be satisfied.

One example communication protocol that can be used between the mobile device 102 and the corresponding recipient device 104 is Near Field Communication (NFC). A communication criterion when using NFC, for instance, is that the mobile device 102 and the corresponding recipient device 104 need to be within a certain distance such that an encrypted radio signal can be communicated between the devices.

Another example communication protocol that can be used between the mobile device 102 and the corresponding recipient device 104 is Quick-Response code (QR code). Either the mobile device 102 or the corresponding recipient device 104 can display a QR code to the other device. A communication criterion when using QR code, for instance, is that the QR code must be displayed by one device to another device within a certain distance in a line of sight, where the distance may be based on the size of the QR code.

Another example communication protocol that can be used between the mobile device 102 and the corresponding recipient device 104 is Magnetic Secure Transmission (MST). A communication criterion when using MST, for instance, is that the mobile device 102 and the corresponding recipient device 104 need to be within a certain distance such that an encrypted magnetic signal can be communicated between the devices.

Another example communication protocol that can be used between the mobile device 102 and the corresponding recipient device 104 is sound-based technology. Either the mobile device 102 or the corresponding recipient device 104 can transmit a sound wave to be received by a microphone on the other device. A communication criterion when using sound-based technology, for instance, is that the mobile device 102 and the corresponding recipient 104 are within certain distance such that the microphone on one device can receive the sound waves transmitted by the other device.

The system 100 can thus streamline the user experience in using a digital credential application by providing one or more digital credential recommendations relevant for the user to use and/or access in a particular context, allowing the user to exchange information with a recipient device more efficiently. For example, in some implementations, the user can directly complete a data exchange in which the system 100 pre-selects and automatically surfaces a digital credential on the mobile device 102, the user can directly complete a data exchange using the digital credential that the system 100 pre-selects and automatically surfaces on the mobile device 102. In some implementations in which the system 100 presents a set containing more than one digital credential recommendations, the user may still directly complete a data exchange using the digital credential that the system 100 ranks first in relevancy to the context that the user is in. Alternatively, the user may select one digital credential to use from the set of digital credential recommendations without having to sift through all digital credentials in the digital credential application.

By automatically surfacing digital credential recommendations to the user, the system 100 can improve the user experience in using the digital credential application. For example, the digital credential application can provide a better user experience for a user who approaches an access point by recommending to the user with a digital credential that allows the user to gain access.

FIG. 2 shows a block diagram of an example digital credential recommendation system 200 for generating and presenting relevant digital credentials.

After receiving a request to generate a set of one or more relevant digital credentials to a user, the digital credential recommendation system 200 feeds an input 206 into a neural network 208.

The input 206 includes at least a context 202 for the request and data identifying one or more candidate digital credentials 204.

A context 202 includes one or more features of the request that characterize a context in which the digital credential recommendation system 200 is generating one or more digital credential recommendations.

The context 202 can, for example, include data characterizing the physical location of the mobile device.

As another example, the context 202 can include data characterizing the semantic location of the mobile device. The mobile device can identify and supply data characterizing its semantic location using one or more of its sensors, such as sensors that sense GPS coordinates, light, sound, Wi-Fi signals, etc. With data collected from one or more of these sensors, the mobile device can determine its semantic location through a variety of techniques, e.g., machine learning techniques or using local search-and-discovery services.

As another example, the context 202 can include data characterizing one or more user activity patterns. A user activity pattern can be a recurring behavior that one or more users exhibit. For example, one or more users may repeatedly use a particular digital credential every interval of time (e.g., a particular time every day, week, or year). Another example is that one or more users may repeatedly use a particular digital credential to apply an active discount, promotion, or reward at physical locations nearby. Another example is that one or more users may repeatedly use a particular digital credential in similar semantic locations. In some implementations, user activity patterns with respect to a given digital credential are represented as structured numerical and categorical features, such as time of use, location type, usage frequency, and promotions used. For example, a user may use a store discount at a grocery store 5 times per week, or a transit pass at a subway station 10 times per week. These examples are represented by both numerical features such as “10 times per week” and categorical features such as use “at a subway station.” These features are then converted into numerical inputs (e.g., one-hot encoding for categorical features, normalization for numerical features) before being fed into the neural network 208. Alternatively, in some implementations in which the neural network 208 is a generative neural network that operates on natural language text sequences, this data can be input as natural language text, such as “User frequently uses a transit pass at a subway station ten times per week.”

The one or more candidate digital credentials 204 are a subset of the digital credentials associated with the digital credential application.

In some implementations, the subset includes all of the digital credentials associated with the digital credential application as candidate digital credentials 204, i.e., the subset is not a proper subset.

In some implementations, the subset can identify candidate digital credentials 204 by performing a search of the plurality of digital credentials associated with the digital credential application based on the identified context. For instance, the digital credential recommendation system 200 can perform a search on a feature of the identified context using a search engine to obtain a list of digital credentials applicable to the identified context. The digital credential recommendation system 200 can send queries to the search engine and filter the search results internally. As an example, the digital credential recommendation system 200 can use a search engine to perform a search on the semantic location of the identified context to obtain a list of all digital credentials that have a relevant discount that can be applied at the semantic location, from which the digital credential recommendation system 200 can identify the digital credentials that are available in the digital credential application. As an alternative example, in addition to the semantic location of the identified context, the digital credential recommendation system 200 can provide all digital credentials associated with the user's digital credential application to the search engine such that the generated search results are limited to all existing digital credential items that the user has. The digital credential recommendation system 200 can perform one search query with one or more features of identified context. Alternatively, the digital credential recommendation system 200 can perform multiple search queries that each contain one or multiple features of the identified context, and then combine the search results of the search queries.

In some implementations, the digital credential recommendation system 200 can identify candidate digital credentials 204 by maintaining data associating each of one or more cached contexts with a respective subset of digital credentials associated with the digital credential application and determining that the context 202 matches at least one of the cached contexts. The digital credential recommendation system 200 can then include in the candidate digital credentials 204 the respective subsets associated with each cached contexts that matches the context 202. To generate the cached contexts, the digital credential recommendation system 200 can perform searches with a search engine on one or more contexts and store the respective search results of lists or sets of digital credentials in a cache. For example, the digital credential recommendation system 200 can use a search engine to search contexts that each identify a different semantic location such as a chain of store, allowing the digital credential recommendation system 200 to generate a cache by storing the corresponding search results of lists or sets of digital credentials that have relevant discounts for each respective semantic location. The digital credential recommendation system 200 can maintain the cached contexts by periodically performing searches on the one or more cached contexts and updating the corresponding search results stored in the cache. Maintaining data associating each of one or more cached contexts with a respective subset of digital credentials associated with the digital credential application can reduce or eliminate the latency in identifying candidate digital credentials 204 for the given context 202.

Having identified one or more candidate digital credentials 204 from the digital credentials associated with the digital credential application, the digital credential recommendation system 200 includes as part of the input 206 along with the context 202, data characterizing each of the candidate digital credentials as input 206 to the neural network 208. Each candidate digital credential can be represented by data such as the credential name, associated entity, and so on. Data characterizing each of the candidate digital credentials that is included as part of the input 206 can be, for instance, a label representing each of the candidate digital credentials. For example, the label can be a natural language text description of the candidate digital credential or a unique identifier for the candidate digital credential.

The neural network 208 processes the input 206 to generate an output 210 that defines a relevance ranking of the candidate digital credentials given the context for the request.

Some example architectures for the neural network will now be described.

In some situations, the neural network can be referred to as an auto-regressive neural network when the neural network auto-regressively generates an output sequence of tokens as the network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

As a particular example, the neural network can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv: 1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv: 2204.02311; Rohan Anil, et al., Palm 2 technical report. arXiv preprint arXiv: 2305.10403, 2023; and Gemini Team, et al., Gemini: a family of highly capable multimodal models. arXiv preprint arXiv: 2312.11805 (2023).

For example, the neural network may be a (generative) language mode neural network. Examples of generative language model neural networks include Sparrow (Glaese, et al., arXiv: 2209.14375), Chinchilla (Hoffmann, et al., arXiv: 2203.15556), and PaLM 2 (Anil, et al., arXiv: 2305:10403).

As another example, the neural network may be a multi-modal model neural network, e.g., a vision language model (VLM) neural network. Examples of multi-modal neural networks include Flamingo (Alayrac, et al., arXiv: 2204.14198), PaLI (Chen, et al., arXiv: 2209.06794), and PaLI-X (Chen, et al., arXiv: 2305.18565).

In some implementations, the neural network 208 can be a pre-trained generative neural network on-board the mobile device. The pre-trained generative neural network generates an output 210 based on a prompt built from the input 206.

In some implementations, the pre-trained generative neural network can be further trained on training examples that the digital credential application generates using local data of data exchanges in which the mobile device communicated information associated with a particular digital credential to another device in a particular context.

Each training example that the digital credential application generates can thus identify a particular context, a particular digital credential that was used in the particular context, and a particular subset of the digital credentials associated with the digital credential application that was available for the user to select from under the particular context.

In some implementations, the neural network 208 can be a neural network that has been trained on training data including a plurality of training examples from a plurality of user devices. That is, the neural network 208 on-board the mobile device has been updated with parameter updates or gradients from a central server, which has received parameter updates or gradients from a plurality of user devices after the neural network 208 on-board each device has been trained with training examples respective to each device. With parameter updates or gradients aggregated from a plurality of user devices by the central server, the output 210 generated by the neural network 208 can thus be customized based on activity of a plurality of other users.

In some implementations, the neural network 208 that has been trained on training data including a plurality of training examples from a plurality of user devices can be further fine-tuned on training examples that are specific to the mobile device. That is, after the neural network 208 on-board has been updated with parameter updates or gradients received from a central server, the neural network 208 can be further trained on training examples that the digital credential application generates using local data, each identifying a particular context, a particular digital credential that the mobile device used in the particular context, and a particular subset of digital credentials associated with the digital credential application that was available to select from as candidate digital credentials.

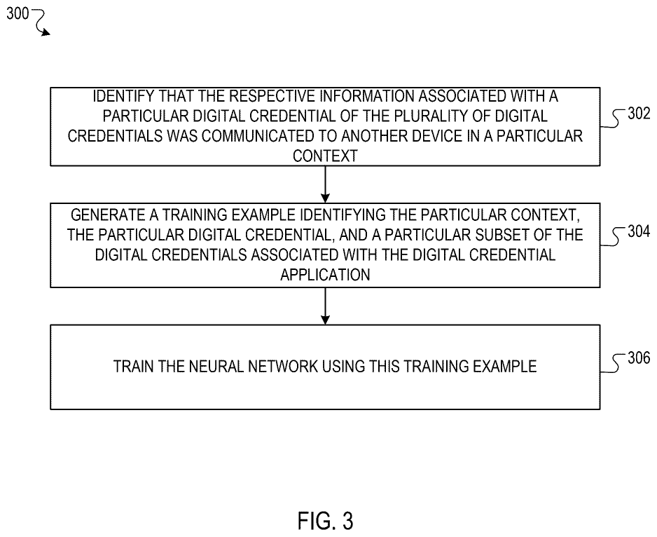

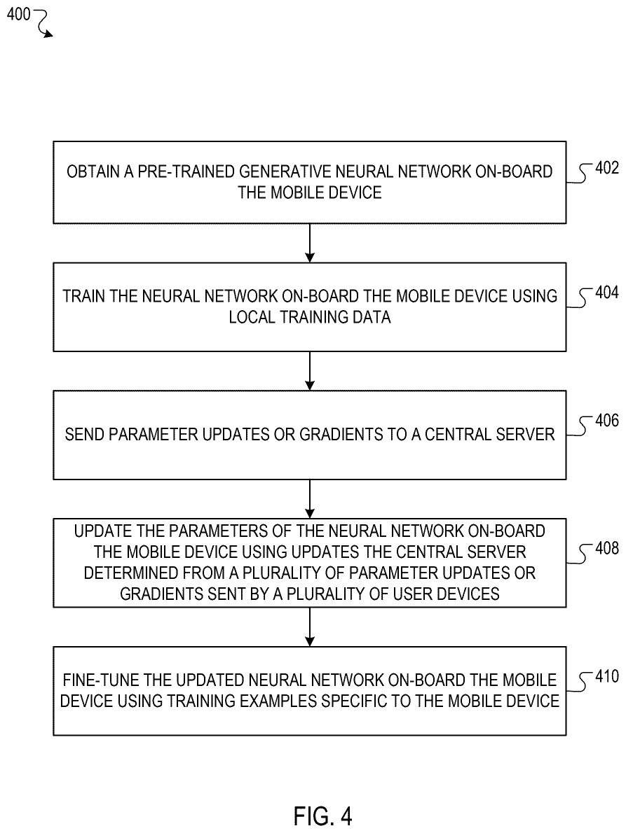

Training the neural network 208 is described in more detail below with reference to FIGS. 3-4.

The neural network 208 produces an output 210 which can be, for example, a ranked list of candidate digital credentials, or a respective score for each of a set of candidate digital credentials. From the output 210, the digital credential recommendation system 200 selects one or more of the candidate digital credentials as the set of one or more relevant digital credentials 212.

The set of relevant digital credentials 212 may include only one relevant digital credential. In this case, the digital credential recommendation system 200 can designate the one relevant digital credential as active within the digital credential application. Once the one relevant digital credential is designated as active, information associated with the one relevant digital credential can be communicated between the mobile device and a particular recipient device when the communication criterion is satisfied.

The set of relevant digital credentials 212 may include more than one relevant digital credential. The mobile device 214 can present data representing all relevant digital credentials or a subset of relevant digital credentials that exceed a certain threshold of relevancy. In some implementations, the digital credential recommendation system 200 presents and pre-selects the most relevant digital credential for use and/or access. In some implementations, the digital credential recommendation system 200 presents a set of one or more relevant digital credentials from which the user can select one digital credential for use and/or access. The one relevant digital credential that is pre-selected by the digital credential recommendation system 200 or selected by the user is designated as active within the digital credential application.

FIG. 3 is a flow diagram of an example process 300 for training of a neural network on-board the mobile device to generate relevant digital credentials. For convenience, the process 300 will be described as being performed by a system of one or more computers located in one or more locations. For example, a digital credential recommendation system, e.g., the digital credential recommendation system 200 depicted in FIG. 2, appropriately programmed in accordance with this specification, can perform the process 300.

To generate a training example for training a neural network in an on-device model, the system first identifies that the respective information associated with a particular digital credential of the plurality of digital credentials was communicated to another device in a particular context (step 302). The communication of information associated with a particular digital credential indicates an affirmative user selection of the particular digital credential under the particular context.

The system then generates a training example identifying the particular context, the particular digital credential, and a particular subset of the digital credentials associated with the digital credential application (step 304). The particular subset of the digital credentials associated with the digital credential application are digital credentials that the digital credential application could have identified as candidate digital credentials when run under the particular context in which the user decided to use the particular digital credential.

The system then trains the neural network using this training example (step 306). That is, the system generates an input from the particular context and candidate digital credentials identified from the particular subset of the digital credentials associated with the digital credential application. The neural network processes the input to generate an output defining a relevance ranking of the candidate digital credentials. The output produced by the neural network can, for instance, be a ranked list of the candidate digital credentials. This ranked list of candidate digital credentials outputted by the neural network can further include a score for each candidate digital credential. As another example, the output produced can be a list or set containing the candidate digital credentials and the respective score for each. Using this output that the neural network produced from processing the training example, the system can determine an error between the particular digital credential that was actually used and the digital credential that the neural network predicts to be most relevant to the user in the particular context. To calculate the error between the neural network's prediction of the most relevant digital credential and the particular digital credential that the training example identifies as having actually been used in the particular context, the system can use a loss function that, for instance, is a function of the difference in respective scores or ranks of the two digital credentials in the output of the neural network. Examples of appropriate loss functions can include cross-entropy losses, hinge loss, and so on. As another example, when the neural network output directly identifies the predicted most relevant digital credential, e.g., as a natural language sequence or other multi-token identifier for the content item, the loss function can be, e.g., a negative log likelihood loss.

In customizing and fine-tuning the neural network to generate a relevance ranking of candidate digital credentials given a particular context, the process 300 can also use parameter-efficient fine-tuning (PEFT) methods to update the neural network of an existing model. For example, the process 300 can use low-rank adaption (LoRA) to fine-tune a small subset of the neural network's weights, reducing the time and resources consumed in customizing and fine-tuning a model with training examples.

FIG. 4 is a flow diagram of an example process 400 for further training a pre-trained generative neural network to customize and fine-tune the recommendation of relevant digital credentials. For convenience, the process 400 will be described as being performed by a system of one or more computers located in one or more locations. For example, a digital credential recommendation system, e.g., the digital credential recommendation system 200 depicted in FIG. 2, appropriately programmed in accordance with this specification, can perform the process 400.

The system first obtains a pre-trained generative neural network on-board the mobile device (step 402). The mobile device can have a pre-trained generative neural network local to the device. The pre-trained generative neural network can be downloaded onto the mobile device as part of the digital credential application.

The system can train the neural network on-board the mobile device using local training data (step 404). Instead of uploading training data from a plurality of users to a server to perform centralized training of the neural network, the system can leverage federated learning, which allows a plurality of user devices to each locally train the model of the neural network obtained on-board using the process 300 as described above for FIG. 3 with training data local to each of the plurality of user devices.

Each of the plurality of user devices send parameter updates or gradients to a central server (step 406). In sending the parameter updates or gradients to a central server, each of the plurality of devices can furthermore apply differential privacy, which can bound the contribution from each of the plurality of user devices on the new neural network and add noise to the data shared with the server such that the data is masked to make it untraceable to any specific user, thereby further protecting the data privacy of users of the plurality of devices. The central server collects and aggregates the parameter updates or gradients it receives from each of the plurality of user devices to update a global model. Having aggregated the parameter updates or gradients from a plurality of devices to build an updated global model, the central server can send parameter updates or gradients to each of the plurality of devices.

Each of the plurality of devices can update the parameters of the neural network on-board the mobile device using updates the central server determined from a plurality of parameter updates or gradients sent by a plurality of user devices (step 408).

Additional rounds of training the neural network on-board the mobile device using local training data (step 404), sending parameter updates or gradients to a central server (step 406), and updating the parameters of the neural network on-board the mobile device using updates the central server determined from a plurality of parameter updates or gradients sent by a plurality of user devices (step 408) can be performed.

The process 400 can further fine-tune the updated neural network on-board the mobile device using training examples specific to the mobile device (step 410). The neural network of the updated model can thus be further trained locally on-board using the process 300 as described above for FIG. 3 with training data specific to the mobile device.

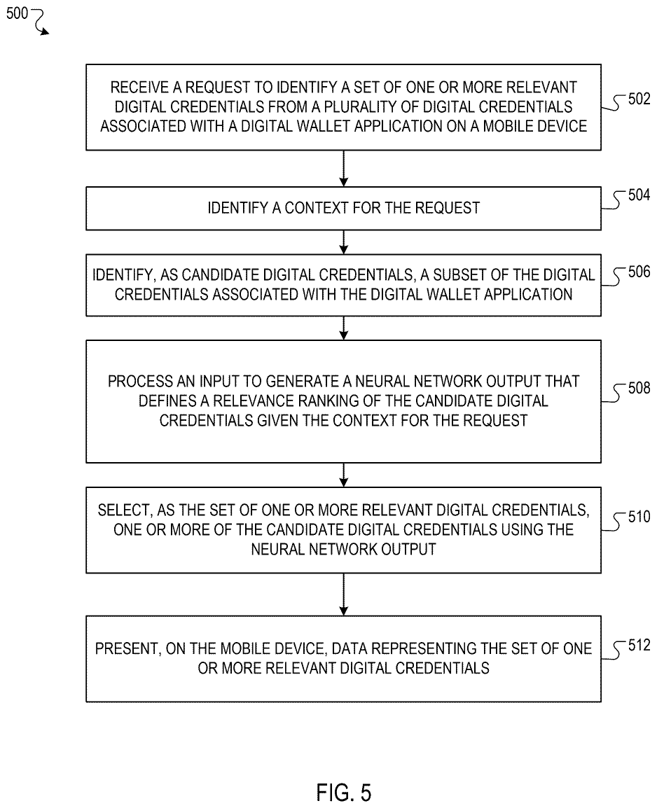

FIG. 5 is a flow diagram of an example process 500 for identifying and presenting to a user a set of one or more relevant digital credentials. For convenience, the process 500 will be described as being performed by a system of one or more computers located in one or more locations. For example, a digital credential recommendation system, e.g., the digital credential recommendation system 200 depicted in FIG. 2, appropriately programmed in accordance with this specification, can perform the process 500.

The system first receives a request to identify a set of one or more relevant digital credentials from a plurality of digital credentials associated with a digital credential application on a mobile device (step 502). Each digital credential is associated with respective information that is communicated to a corresponding recipient device when the digital credential is designated as active within the digital credential application and a communication criterion is satisfied.

Upon receiving the request, the system identifies a context for the request (step 504).

The system further identifies, as candidate digital credentials, a subset of the digital credentials associated with the digital credential application (step 506).

The system processes the identified context and candidate digital credentials as an input to generate a neural network output that defines a relevance ranking of the candidate digital credentials given the context for the request (step 508). The input includes the context for the request and data characterizing each of the candidate digital credentials. The system feeds this input into the neural network on-board the mobile device.

The system selects as the set of one or more relevant digital credentials, one or more of the candidate digital credentials using the neural network output (step 510).

The system then presents, on the mobile device, data representing the set of one or more relevant digital credentials (step 512).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving a request to identify a set of one or more relevant digital credentials from a plurality of digital credentials associated with a digital credential application on a mobile device, wherein each digital credential is associated with respective information that is communicated to a corresponding recipient device when (i) the digital credential is designated as active within the digital credential application and (ii) a communication criterion is satisfied;
identifying a context for the request;
identifying, as candidate digital credentials, a subset of the digital credentials associated with the digital credential application;
generating an input comprising (i) the context for the request and (ii) a respective label characterizing each of the candidate digital credentials in the identified subset of the digital credentials associated with the digital credential application;
processing the input using a neural network to generate a neural network output that defines a relevance ranking of the candidate digital credentials given the context for the request;
selecting, as the set of one or more relevant digital credentials, one or more of the candidate digital credentials using the neural network output; and
presenting, on the mobile device, data representing the set of one or more relevant digital credentials.

2. The method of claim 1, further comprising:
after presenting the data representing the set of one or more relevant digital credentials:
determining that the communication criterion is satisfied between the mobile device and a particular recipient device; and
in response, communicating the respective information associated with one of the relevant digital credentials to the particular recipient device.

3. The method of claim 1, wherein the set of one or more relevant digital credentials includes only one relevant digital credential and wherein the method further comprises:
designating the relevant digital credential as active within the digital credential application.

4. The method of claim 1, wherein the set of one or more relevant digital credentials includes a plurality of relevant digital credentials and wherein the method further comprises:
after presenting the data representing the set of relevant digital credentials on the mobile device, receiving a user input selecting one of the relevant digital credentials; and
designating the selected relevant digital credential as active within the digital credential application.

5. The method of claim 1, further comprising:
identifying that the respective information associated with a particular digital credential of the plurality of digital credentials was communicated to another device in a particular context;
generating a training example identifying the particular context, the particular digital credential, and a particular subset of the digital credentials associated with the digital credential application; and
training the neural network using the training example.

6. The method of claim 1, wherein the neural network is a pre-trained generative neural network.

7. The method of claim 1, wherein the neural network has been trained on training data that includes a plurality of training examples from a plurality of user devices, each training example comprising a respective context identified by a respective user device, a respective set of candidate digital credentials, and a respective digital credential from the respective set of candidate digital credentials that was used in the respective context.

8. The method of claim 7, wherein, after the training on the training data that includes the plurality of training examples from the plurality of user devices, the neural network has been fine-tuned on training examples that are specific to the mobile device.

9. The method of claim 1, wherein the request is a user request to access the digital credential application.

10. The method of claim 1, wherein the request is an automated system request for digital credential recommendations that is triggered by detection of a trigger event.

11. The method of claim 1, wherein identifying the context for the request comprises identifying data characterizing a semantic location of the mobile device.

12. The method of claim 1, wherein identifying the context for the request comprises identifying data characterizing a physical location of the mobile device.

13. The method of claim 1, wherein identifying the context for the request comprises identifying data characterizing one or more user activity patterns.

14. The method of claim 1, wherein identifying, as candidate digital credentials, the subset of the digital credentials associated with the digital credential application comprises identifying all of the digital credentials associated with the digital credential application as candidate digital credentials.

15. The method of claim 1, wherein identifying, as candidate digital credentials, the subset of the digital credentials associated with the digital credential application comprises performing a search of the plurality of digital credentials associated with the digital credential application based on the identified context to identify the subset of digital credentials.

16. The method of claim 1, wherein identifying, as candidate digital credentials, the subset of the digital credentials associated with the digital credential application comprises:
maintaining data associating each of one or more cached contexts with a respective subset of the digital credentials associated with the digital credential application;
determining that the context matches at least one of the cached contexts; and
including, in the candidate digital credentials, the respective subsets associated with each of the at least one matching cached context.

17. A system comprising one or more computers and one or more storage devices storing instructions that when executed by the one or more computers cause the one or more computers to perform operations comprising:
receiving a request to identify a set of one or more relevant digital credentials from a plurality of digital credentials associated with a digital credential application on a mobile device, wherein each digital credential is associated with respective information that is communicated to a corresponding recipient device when (i) the digital credential is designated as active within the digital credential application and (ii) a communication criterion is satisfied;
identifying a context for the request;
identifying, as candidate digital credentials, a subset of the digital credentials associated with the digital credential application;
generating an input comprising (i) the context for the request and (ii) a respective label characterizing each of the candidate digital credentials in the identified subset of the digital credentials associated with the digital credential application;
processing the input using a neural network to generate a neural network output that defines a relevance ranking of the candidate digital credentials given the context for the request;
selecting, as the set of one or more relevant digital credentials, one or more of the candidate digital credentials using the neural network output; and
presenting, on the mobile device, data representing the set of one or more relevant digital credentials.

18. The system of claim 17, wherein the operations further comprise:
after presenting the data representing the set of one or more relevant digital credentials:
determining that the communication criterion is satisfied between the mobile device and a particular recipient device; and
in response, communicating the respective information associated with one of the relevant digital credentials to the particular recipient device.

19. The system of claim 17, wherein the operations further comprise:
identifying that the respective information associated with a particular digital credential of the plurality of digital credentials was communicated to another device in a particular context;
generating a training example identifying the particular context, the particular digital credential, and a particular subset of the digital credentials associated with the digital credential application; and
training the neural network using the training example.

20. One or more non-transitory computer storage media storing instructions that when executed by one or more computers cause the one or more computers to perform operations comprising:
receiving a request to identify a set of one or more relevant digital credentials from a plurality of digital credentials associated with a digital credential application on a mobile device, wherein each digital credential is associated with respective information that is communicated to a corresponding recipient device when (i) the digital credential is designated as active within the digital credential application and (ii) a communication criterion is satisfied;
identifying a context for the request;
identifying, as candidate digital credentials, a subset of the digital credentials associated with the digital credential application;
generating an input comprising (i) the context for the request and (ii) data-a respective label characterizing each of the candidate digital credentials in the identified subset of the digital credentials associated with the digital credential application;
processing the input using a neural network to generate a neural network output that defines a relevance ranking of the candidate digital credentials given the context for the request;
selecting, as the set of one or more relevant digital credentials, one or more of the candidate digital credentials using the neural network output; and
presenting, on the mobile device, data representing the set of one or more relevant digital credentials.
